(19) United States
(12) Patent Application Publication
(10) Pub. No.: US 2026/0075476 A1
(43) Pub. Date: Mar. 12, 2026

(54) INTER-NODE RELATIONSHIP INFORMATION INDICATION FOR MACHINE LEARNING (ML) BASED MOBILITY

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US); Hamed PEZESHKI, San Diego, CA (US)

(21) Appl. No.: 18/883,310

(22) Filed: Sep. 12, 2024

(51) Int. Cl. H04W 36/00; H04L 41/16; H04W 52/34

(52) U.S. Cl. CPC H04W 36/0072; H04L 41/16; H04W 36/0061; H04W 52/34

(57) ABSTRACT

Certain aspects of the present disclosure provide techniques for inter-node relationship information indication for artificial intelligence/machine learning (AI/ML)-based mobility. An example method, performed at a user equipment (UE), generally includes receiving signaling configuring the UE with (i) measurement resources, (ii) prediction target resources, and (iii) topological information for a set of cells and beams, and participating in mobility procedures involving a machine learning (ML) model and predictions for the prediction target resources, based on the topological information and measurements taken for the measurement resources.

### FIELD OF THE DISCLOSURE

Aspects of the present disclosure relate to wireless communications, and more particularly, to techniques for inter-node relationship information indication for machine learning (ML)-based mobility.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving signaling configuring the UE with (i) measurement resources, (ii) prediction target resources, and (iii) topological information for a set of cells and beams used in the set of cells; and participating in mobility procedures involving channel characteristics a predicted for the prediction target resources using a machine learning (ML) model, based on the topological information and measurements taken for the measurement resources.

Another aspect provides a method for wireless communication at a network entity. The method includes transmitting signaling configuring a user equipment (UE) with (i) measurement resources, (ii) prediction target resources, and (iii) topological information for a set of cells and beams used in the set of cells; and participating in mobility procedures involving channel characteristics a predicted for the prediction target resources using a machine learning (ML) model, based on the topological information and measurements taken for the measurement resources.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates example beam refinement procedures.

FIG. 6 is a diagram illustrating example operations where beam management may be performed.

FIG. 7 illustrates a general functional framework applied for AI-enabled RAN intelligence.

FIG. 8 depicts a call flow diagram, in accordance with certain aspects of the present disclosure.

FIG. 9 depicts a diagram 900 illustrating example topological information between network nodes, in accordance with certain aspects of the present disclosure.

FIG. 10 depicts a method for wireless communications.

FIG. 11 depicts a method for wireless communications.

FIG. 12 depicts aspects of an example communications device.

### DETAILED DESCRIPTION

Aspects of the present disclosure provide apparatuses, methods, processing systems, and computer-readable mediums for inter-node relationship information indication for artificial intelligence/machine learning (AI/ML)-based mobility.

In advanced wireless systems, mobility procedures are in place to help maintain network connections for a user equipment (UE) as it moves between the coverage areas of different cells. Mobility procedures generally refer to mechanisms that allow a UE to transition from being served by a source cell to being served by a target cell. In some cases, for physical layer (PHY or Layer 1/L1) and/or medium access control layer (MAC or Layer 2/L2), also referred to as L1/L2 triggered mobility (LTM), as a UE moves, a new serving cell (e.g. a primary cell (Pcell)) may be selected (e.g., reselected) among a set of pre-configured candidate cells based on L1 measurement for those cells.

Temporal beam prediction, also known as time-domain (TD) beam prediction, generally refers to a technique used in wireless communications to anticipate and optimize the direction of transmission and/or reception beams over time. Temporal beam prediction may involve predicting a beam that will be suitable (preferred) for use in the future. The prediction may be based on current measurements of reference signals sent using different beams (which may or may not include the predicted beam). Temporal beam prediction may be particularly relevant in scenarios where the wireless channel conditions change rapidly, such as in high-mobility environments or in the presence of fading effects.

In wireless communication systems that employ beamforming, multiple antennas may be used to transmit and receive signals. By dynamically adjusting the direction of the transmit beam, the transmitted energy may be focused towards the intended receiver, which may mitigate interference from other directions. However, due to the dynamic nature of wireless channels, the optimal beam direction can change rapidly, leading to suboptimal performance if the beamforming strategy is not continuously and effectively updated.

Beam prediction addresses this challenge by utilizing channel state information (CSI) and exploiting spatial and/or temporal correlations in the wireless channel. By analyzing (current and past) channel measurements, such as received signal strength, signal quality, and/or channel characteristics, it is possible to infer the future behavior of the wireless channel and predict the optimal beam direction.

In some cases, AI and/or ML models (collectively referred to herein as ML models) may be trained and used (e.g., at a network entity and/or a UE) to improve wireless communications. For example, ML models may be used to perform temporal beam prediction and/or spatial beam prediction (e.g., prediction for a set of beams, Set-A, based on measurements of a different set of beams, Set-B). For example, such a model may predict channel characteristics of Set-A beams based on measurement results (e.g., historic measurement results) of Set-B beams (e.g., where Set-A beams are (CSI-RS like) narrower than Set-B beams (SSB like). Set-A beams and Set-B beams may be the same (e.g., pure temporal beam prediction) or may be different (e.g., spatial and temporal beam prediction). Such beam prediction may be performed by a model at the network entity and/or a UE. An identifier (e.g., an associated identifier (ID)) may be utilized for achieving consistency between training and inference.

For AI/ML based mobility, cell level measurement prediction may be viewed as an extension of beam level measurement prediction to cell level measurement prediction for serving and candidate cells (e.g., based on UE-side or network-side AI/ML models). AI/ML models may be used for measurement events prediction and radio link failure (RLF) or handover failure (HOF) prediction. The AI/ML based mobility use cases' performance may depend on topological information (e.g., cell/beam information) of the network (e.g., among gNBs), such as relative distance, beam correlation among gNBs, configurations, and status.

Aspects of the present disclosure provide techniques for providing/communicating/indicating different topological information to the UE and between network nodes (e.g., gNBs, source cells, and/or neighboring cells). In some aspects, inter-node signaling may be used for determining the topological information.

Utilization of the techniques disclosed herein may help improve beam prediction. Improved beam prediction may result in improved reliability and performance, which may lead to better quality of service and user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

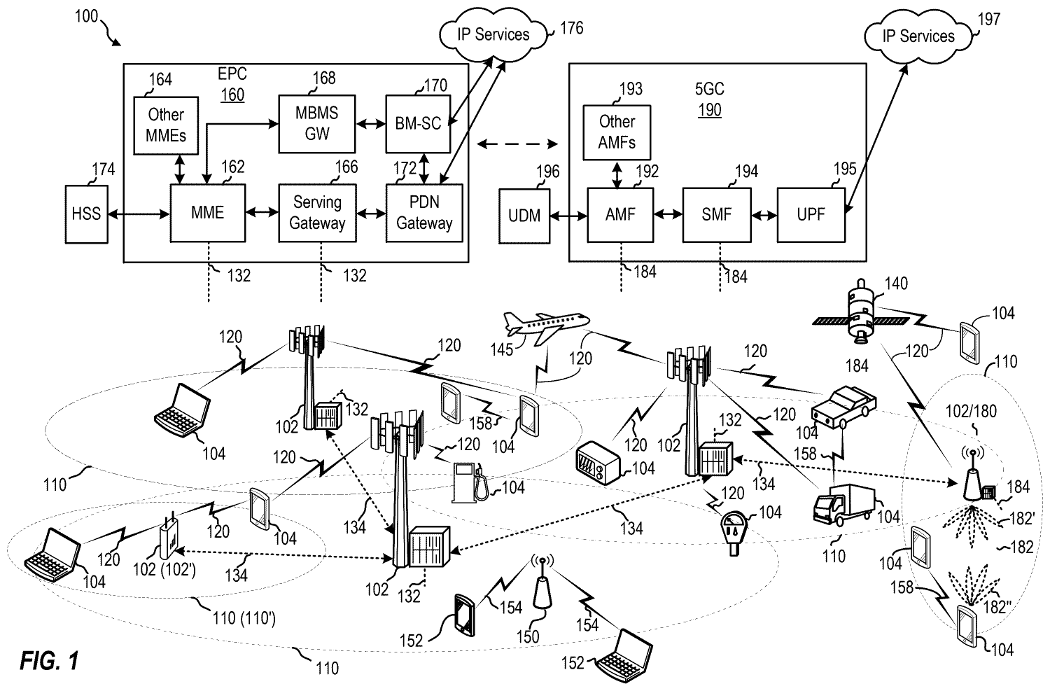

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

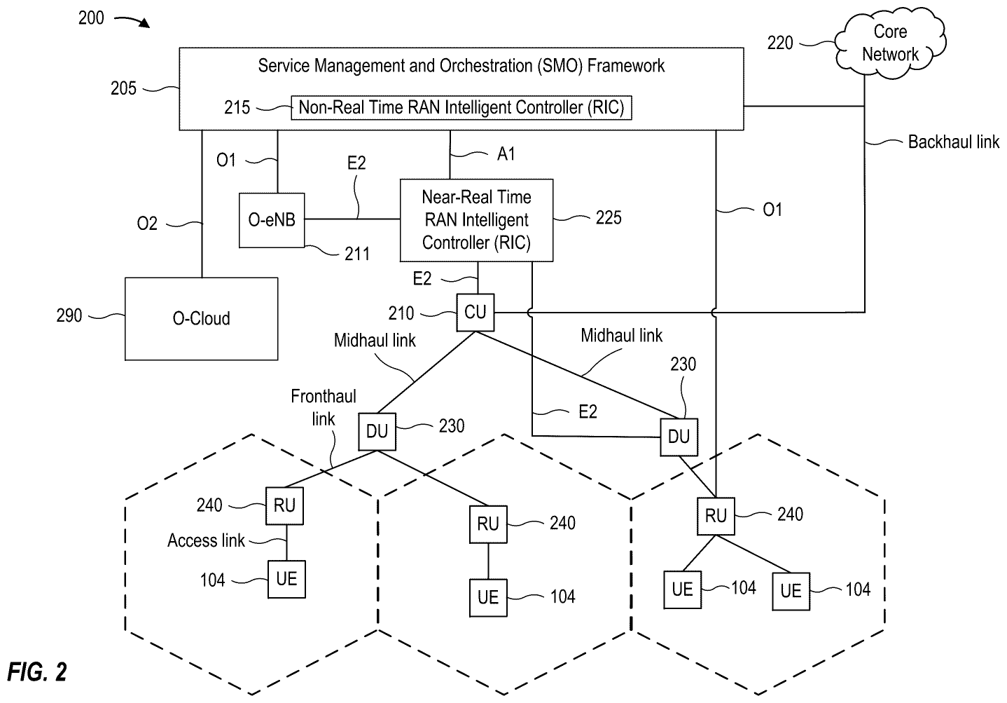

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

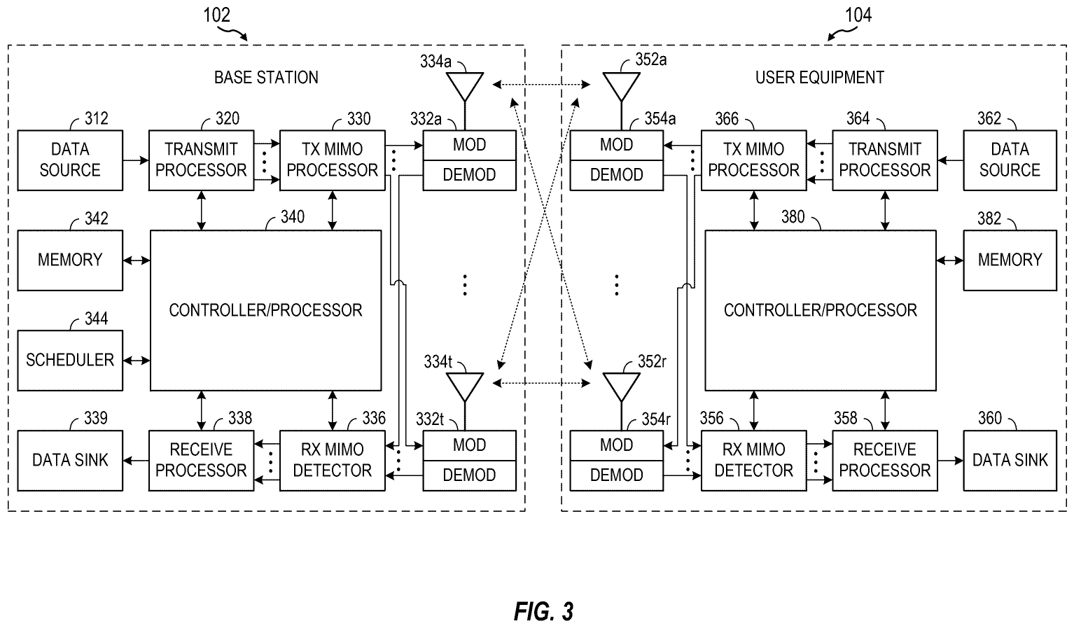

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

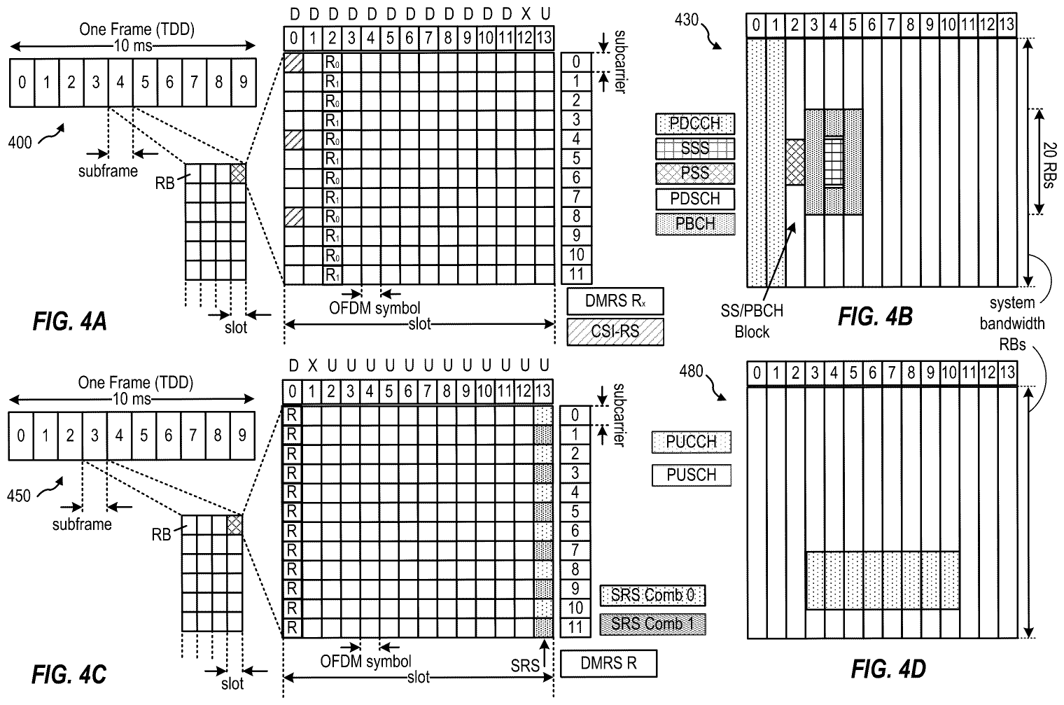

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 us.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Ports and TCI States

In many cases, it is important for a UE to know which assumptions it can make on a channel corresponding to different transmissions. For example, the UE may need to know which reference signals (RSs) it can use to estimate the channel in order to decode a transmitted signal (e.g., PDCCH or PDSCH). It may also be important for the UE to be able to report relevant channel state information (CSI) to the BS (e.g., a gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL'd”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signaling, while a UE may be signaled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source RS in the top block and may be associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be a PDSCH's DMRS. In some cases, for example, a target RS may be any other RS (e.g., PUSCH DMRS, CSIRS, TRS, and SRS).

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:

QCL-TypeA: {Doppler shift, Doppler spread, average delay, delay
spread},
QCL-TypeB: {Doppler shift, Doppler spread},
QCL-TypeC: {average delay, Doppler shift}, and
QCL-TypeD: {Spatial Rx parameter},

Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial ControlResourceSet CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., a number of RBs) assigned to the CORESET, contiguous time duration of the CORESET in a number of symbols, and Transmission Configuration Indicator (TCI) states.

As noted above, a subset of the TCI states provide QCL relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Search space information may also be provided via RRC signaling. For example, the SearchSpace IE is another RRC IE that defines how and where to search for PDCCH candidates for a given CORESET. Each search space is associated with one CORESET. The SearchSpace IE identifies a search space configured for a CORESET by a search space ID. In some aspects, the search space ID associated with CORESET #0 is SearchSpace ID #0. The search space is generally configured via PBCH (MIB).

### Example Beam Refinement Procedures

In mmWave systems, beamforming may be important to overcome high path-losses. As described herein, beamforming may refer to establishing a link between a BS and UE, wherein both of the devices form a beam corresponding to each other. Both the BS and the UE find at least one adequate beam to form a communication link. BS-beam and UE-beam form what is known as a beam pair link (BPL). As an example, on the DL, a BS may use a transmit beam and a UE may use a receive beam corresponding to the transmit beam to receive the transmission. The combination of a transmit beam and corresponding receive beam may be a BPL.

As a part of beam management, beams which are used by BS and UE have to be refined from time to time because of changing channel conditions, for example, due to movement of the UE or other objects. Additionally, the performance of a BPL may be subject to fading due to Doppler spread. Because of changing channel conditions over time, the BPL should be periodically updated or refined. Accordingly, it may be beneficial if the BS and the UE monitor beams and new BPLs.

At least one BPL has to be established for network access. As described above, new BPLs may need to be discovered later for different purposes. The network may decide to use different BPLs for different channels, or for communicating with different BSs (TRPs) or as fallback BPLs in case an existing BPL fails.

The UE typically monitors the quality of a BPL, and the network may refine a BPL from time to time.

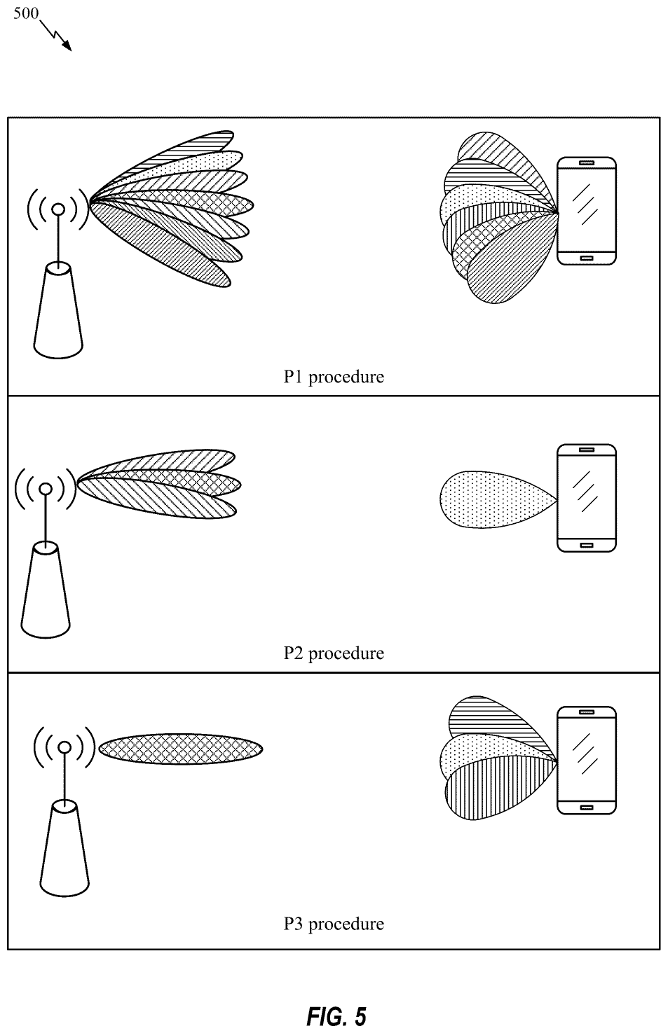

FIG. 5 illustrates example 500 for BPL discovery and refinement. In 5G-NR, the P1, P2, and P3 procedures are used for BPL discovery and refinement. The network uses a P1 procedure to enable the discovery of new BPLs. In the P1 procedure, as illustrated in FIG. 5, the BS transmits different symbols of a reference signal, each beam formed in a different spatial direction such that several (e.g., most or all) relevant places of the cell are reached. Stated otherwise, the BS transmits beams using different transmit beams over time in different directions.

For successful reception of at least a symbol of this “P1-signal”, the UE has to find an appropriate receive beam. It searches using available receive beams and applying a different UE-beam during each occurrence of the periodic P1-signal.

Once the UE has succeeded in receiving a symbol of the P1-signal, it has discovered a BPL. The UE may not want to wait until it has found the best UE receive beam, since this may delay further actions. The UE may measure the reference signal receive power (RSRP) and report the symbol index together with the RSRP to the BS. Such a report will typically contain the findings of one or more BPLs.

In an example, the UE may determine a received signal having a high RSRP. The UE may not know which beam the BS used to transmit; however, the UE may report to the BS the time at which it observed the signal having a high RSRP. The BS may receive this report and may determine which BS beam the BS used at the given time.

The BS may then offer P2 and P3 procedures to refine an individual BPL. The P2 procedure refines the BS-beam of a BPL. For example, the BS may transmit a few symbols of a reference signal with different BS-beams that are spatially close to the BS-beam of the BPL (the BS performs a sweep using neighboring beams around the selected beam). In P2, the UE keeps its beam constant. Thus, while the UE uses the same beam as in the BPL (as illustrated in P2 procedure in FIG. 5). The BS-beams used for P2 may be different from those for P1 in that they may be spaced closer together or they may be more focused. The UE may measure the RSRP for the various BS-beams and indicate the best one to the BS.

The P3 procedure refines the UE-beam of a BPL (see P3 procedure in FIG. 5). While the BS-beam stays constant, the UE scans using different receive beams (the UE performs a sweep using neighboring beams). The UE may measure the RSRP of each beam and identify the best UE-beam. Afterwards, the UE may use the best UE-beam for the BPL and report the RSRP to the BS.

Over time, the BS and UE establish several BPLs. When the BS transmits a certain channel or signal, it lets the UE know which BPL will be involved, such that the UE may tune in the direction of the correct UE receive beam before the signal starts. In this manner, every sample of that signal or channel may be received by the UE using the correct receive beam. In an example, the BS may indicate for a scheduled signal (e.g., SRS, CSI-RS) or channel (e.g., PDSCH, PDCCH, PUSCH, and/or PUCCH) which BPL is involved. In NR, this information may be referred to as a quasi co-location (QCL) indication.

Two antenna ports are quasi co-located (QCL) if properties of the channel over which a symbol on one antenna port is conveyed may be inferred from the channel over which a symbol on the other antenna port is conveyed. QCL supports, at least, beam management functionality, frequency/timing offset estimation functionality, and radio resource management (RRM) functionality.

The BS may use a BPL which the UE has received in the past. The transmit beam for the signal to be transmitted and the previously-received signal both point in a same direction or are QCL. The QCL indication may be needed by the UE (in advance of signal to be received) such that the UE may use a correct receive beam for each signal or channel. Some QCL indications may be needed from time to time when the BPL for a signal or channel changes and some QCL indications are needed for each scheduled instance. The QCL indication may be transmitted in the downlink control information (DCI), which may be part of the PDCCH channel. Because DCI is needed to control the information, it may be desirable that the number of bits needed to indicate the QCL is not too big. The QCL may be transmitted in a medium access control-control element (MAC-CE) or radio resource control (RRC) message.

According to one example, whenever the UE reports a BS beam that it has received with sufficient RSRP, and the BS decides to use this BPL in the future, the BS assigns it a BPL tag. Accordingly, two BPLs having different BS beams may be associated with different BPL tags. BPLs that are based on the same BS beams may be associated with the same BPL tag. Thus, according to this example, the tag is a function of the BS beam of the BPL.

As noted above, wireless systems, such as millimeter wave (mmW) systems, bring gigabit speeds to cellular networks, due to availability of large amounts of bandwidth. However, the unique challenges of heavy path-loss faced by such wireless systems necessitate new techniques such as hybrid beamforming (analog and digital), which are not present in 3G and 4G systems. Hybrid beamforming may enhance link budget/signal to noise ratio (SNR) that may be exploited during the RACH.

In such systems, the node B (NB) and the user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

Since the direction of a reference signal is unknown to the UE, the UE may evaluate several beams to obtain the best Rx beam for a given NB Tx beam. However, if the UE has to “sweep” through all of its Rx beams to perform the measurements (e.g., to determine the best Rx beam for a given NB Tx beam), the UE may incur significant delay in measurement and battery life impact. Moreover, having to sweep through all Rx beams is highly resource inefficient. Thus, aspects of the present disclosure provide techniques to assist a UE when performing measurements of serving cells and neighbor cells when using Rx beamforming.

### Example Beam Management

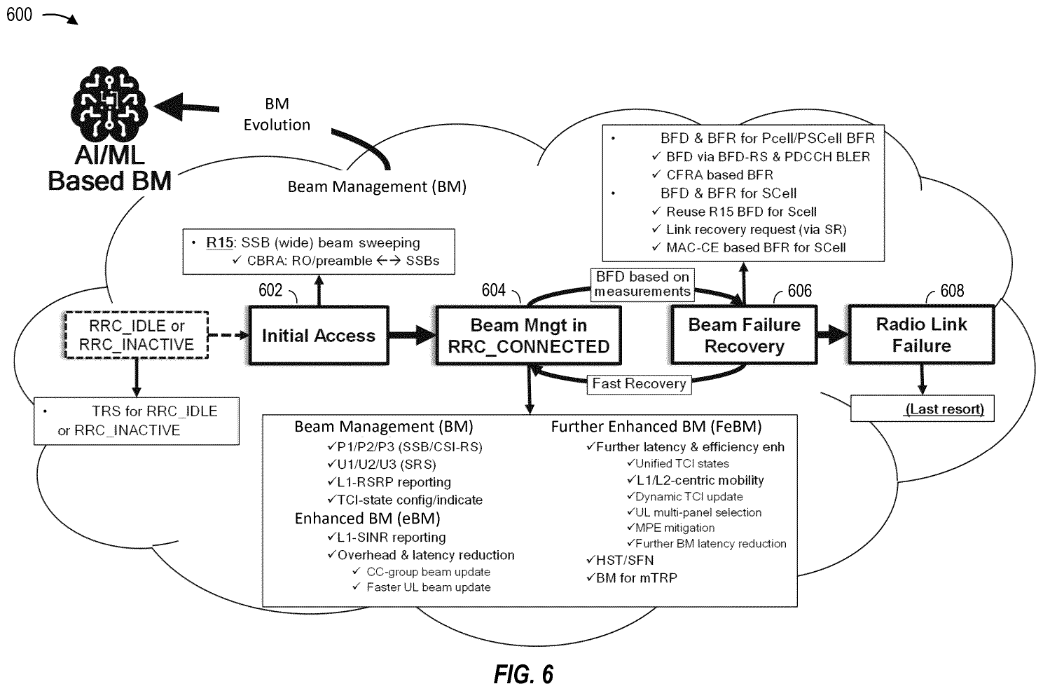

In wireless communications, various procedures may be performed for beam management. FIG. 6 is a diagram illustrating example operations where beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention-based Random Access (CBRA) procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 (e.g., a RACH procedure) to recover from the RLF.

### Example Framework for AI/ML in a Radio Access Network

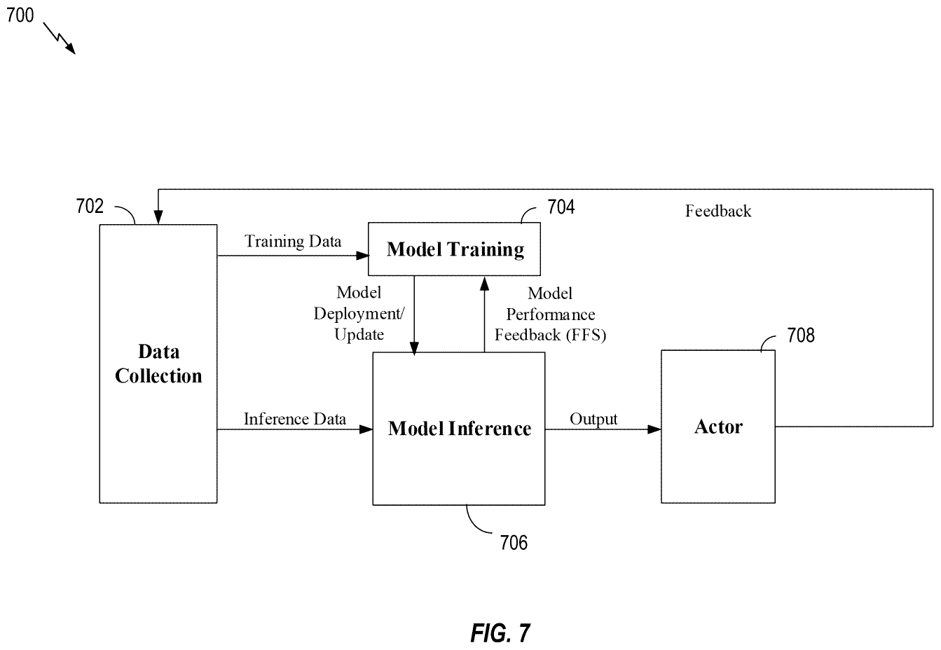

FIG. 7 depicts an example of AI/ML functional framework 700 for RAN intelligence, in which aspects described herein may be implemented.

The AI/ML functional framework includes a data collection function 702, a model training function 704, a model inference function 706, and an actor function 708, which interoperate to provide a platform for collaboratively applying AI/ML to various procedures in RAN.

The data collection function 702 generally provides input data to the model training function 704 and the model inference function 706. AI/ML algorithm specific data preparation (e.g., data pre-processing and cleaning, formatting, and transformation) may not be carried out in the data collection function 702.

Examples of input data to the data collection function 702 (or other functions) may include measurements from UEs or different network entities, feedback from the actor function, and output from an AI/ML model. In some cases, analysis of data needed at the model training function 704 and the model inference function 706 may be performed at the data collection function 702. As illustrated, the data collection function 702 may deliver training data to the model training function 704 and inference data to the model inference function 706.

The model training function 704 may perform AI/ML model training, validation, and testing, which may generate model performance metrics as part of the model testing procedure. The model training function 704 may also be responsible for data preparation (e.g., data pre-processing and cleaning, formatting, and transformation) based on the training data delivered by the data collection function 702, if required.

The model training function 704 may provide model deployment/update data to the model inference function 706. The model deployment/update data may be used to initially deploy a trained, validated, and tested AI/ML model to the model inference function 706 or to deliver an updated model to the model inference function 706.

As illustrated, the model inference function 706 may provide AI/ML model inference output (e.g., predictions or decisions) to the actor function 708 and may also provide model performance feedback to the model training function 704, at times. The model inference function 706 may also be responsible for data preparation (e.g., data pre-processing and cleaning, formatting, and transformation) based on inference data delivered by the data collection function 702, at times.

The inference output of the AI/ML model may be produced by the model inference function 706. Specific details of this output may be specific in terms of use cases. The model performance feedback may be used for monitoring the performance of the AI/ML model, at times. In some cases, the model performance feedback may be delivered to the model training function 704, for example, if certain information derived from the model inference function is suitable for improvement of the AI/ML model trained in the model training function 704.

The model inference function 706 may signal the outputs of the model to nodes that have requested them (e.g., via subscription), or nodes that take actions based on the output from the model inference function. An AI/ML model used in a model inference function 706 may need to be initially trained, validated and tested by a model training function before deployment. The model training function 704 and model inference function 706 may be able to request specific information to be used to train or execute the AI/ML algorithm and to avoid reception of unnecessary information. The nature of such information may depend on the use case and on the AI/ML algorithm.

The actor function 708 may receive the output from the model inference function 706, which may trigger or perform corresponding actions. The actor function 708 may trigger actions directed to other entities or to itself. The feedback generated by the actor function 708 may provide information used to derive training data, inference data or to monitor the performance of the AI/ML Model. As noted above, input data for a data collection function 702 may include this feedback from the actor function 708. The feedback from the actor function 708 or other network entities (e.g., via Data Collection function) may also be used at the model inference function 706.

The AI/ML functional framework 700 may be deployed in various RAN intelligence-based use cases. Such use cases may include CSI feedback enhancement, enhanced beam management (BM), positioning and location (Pos-Loc) accuracy enhancement, and various other use cases.

For UE-sided AI/ML models developed at the UE (e.g., trained and/or updated), the process may involve several steps. One example of such a process is as follows. First, the network signals the data collection configurations and associated IDs (e.g., associated IDs for each (sub) use case in relation with network-side additional conditions). Next, the UE collects data corresponding to these IDs, and AI/ML models are then developed (e.g., trained and/or updated) at the UE based on this collected data corresponding to the associated IDs. Subsequently, the UE reports information about its AI/ML models corresponding to the associated IDs to the network, including a relationship between model IDs determined/assigned for each AI/ML model. Model IDs can be determined in various ways, such as assignment by the network, assignment or reporting by the UE, assuming associated IDs as model IDs, or by predefined rules specified in the network standards specifications.

The reporting of AI/ML models may help model inference and may help ensure consistency. The exact method of assigning or determining model IDs may be flexible, including specifics of reporting and how additional interactions between the UE and network can resolve consistency issues without explicit model identification.

### Aspects Related to Inter-Node Relationship Information for AI/ML-Based Mobility

As noted above, the performance of AI/ML based mobility use cases may depend on topological information (e.g., cell/beam information) of the network (e.g., among gNBs). This topological information may include, for example, relative distance, beam correlation among gNBs, configurations, and status. Aspects of the present disclosure provide techniques for providing/communicating/indicating different topological information to the UE and between network nodes (e.g., gNBs, source cells, and/or neighboring cells). In some aspects, inter-node signaling may be used for determining the topological information.

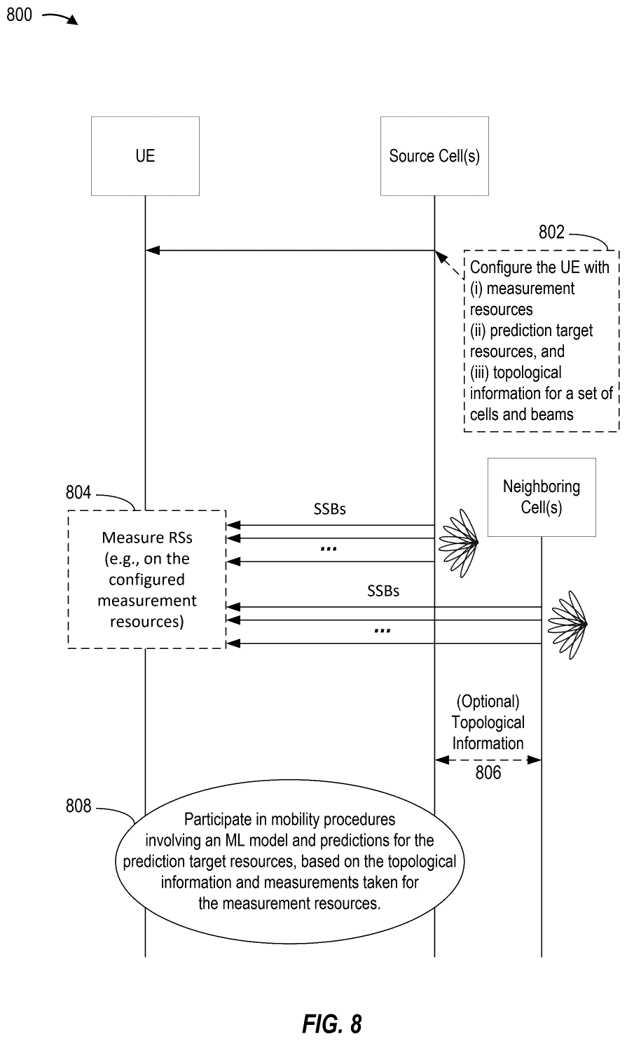

These techniques may be understood with reference to FIG. 8, which depicts a call flow diagram 800, in accordance with certain aspects of the present disclosure. In some aspects, the network entity may be an example of the BS 102 depicted and described with respect to FIGS. 1 and 3 or a disaggregated base station depicted and described with respect to FIG. 2. Similarly, the UE may be an example of UE 104 depicted and described with respect to FIGS. 1 and 3. However, in other aspects, the UE may be another type of wireless communications device and the network entity may be another type of network entity or network node, such as those described herein.

As illustrated at 802, one or more source cell(s) may configure the UE with (i) measurement resources (ii) prediction target resources, and (iii) topological information for a set of cells and beams.

As illustrated at 804, the UE may measure RSs (e.g., SSBs) from source cell(s) and neighboring cell(s) (e.g., on the configured measurement resources).

As illustrated at 806, neighboring cell(s) and source cell(s) may (optionally) communicate topological information. For example, the neighboring cell(s) may transmit topological information to the source cell(s).

As illustrated at 808, the UE and the source cell(s) may participate in mobility procedures involving an ML model and predictions for the prediction target resources, based on the topological information and measurements taken for the measurement resources.

For beam management use cases, a data collection configuration (e.g., and/or resource configuration for prediction and measurements), and associated ID(s) may be used. This may be represented by F_{R}={A, B, Φ}, where A is the set A beam configuration to be predicted by the UE, B is the set B configuration measured, and Φ is the associated ID representing serving gNB configuration (e.g., codebook index, beam tilt, etc.).

For AI/ML based mobility use cases, serving and neighboring cell resource configurations and associated IDs are useful information. For example, a UE may be provided with

$${F}_{R} = \{ {F}_{R}^{s} , {F}_{R}^{N 1} , {F}_{R}^{N 2} , … {F}_{R}^{N k} \} ,$$

where

$${F}_{R}^{s} = \{ {A}^{s} , {B}^{s} , {Φ}^{s} \}$$

indicates the resource configuration and associated ID at a serving cell and

$${F}_{R}^{N M} = \{ {A}^{N M} , {B}^{N M} , {Φ}^{N M} \}$$

indicates the resource configuration and associated ID at an Mth neighboring cell.

However, while serving and neighboring cells resource configurations and associated IDs are useful information, they may not be the complete information. In some cases, additional topological information (e.g., neighbor cell/beam relation information such as beam/cell correlation) may be advantageous (e.g., or needed). Beam correlation may be quantitative information indicating correlation metrics, such as relative tile, how much beams from neighboring gNBs are overlapped, and the like.

According to certain aspects of the present disclosure, topological information may be provided in accordance with certain options. According to a first option (Option 1), complete layout information may be provided. For example, information regarding how different gNBs (e.g., and associated cells/beams) are deployed in a region. This may be advantageous because it contains a complete set of information for a location, and thus, AI/ML models may be specialized for the geographical location. However, it may be more difficult to generalize AI/ML models for different geographical regions when using Option 1.

According to a second option (Option 2), pairwise information may be provided. For example, information regarding relationship(s) between (e.g., two) different gNBs (e.g., and associated cells/beams) may be provided. Additionally, information regarding how beams of different gNBs are correlated (e.g., correlation factor, etc.) may be provided. This may be advantageous because it may help with generalizing AI/ML models for different geographical regions.

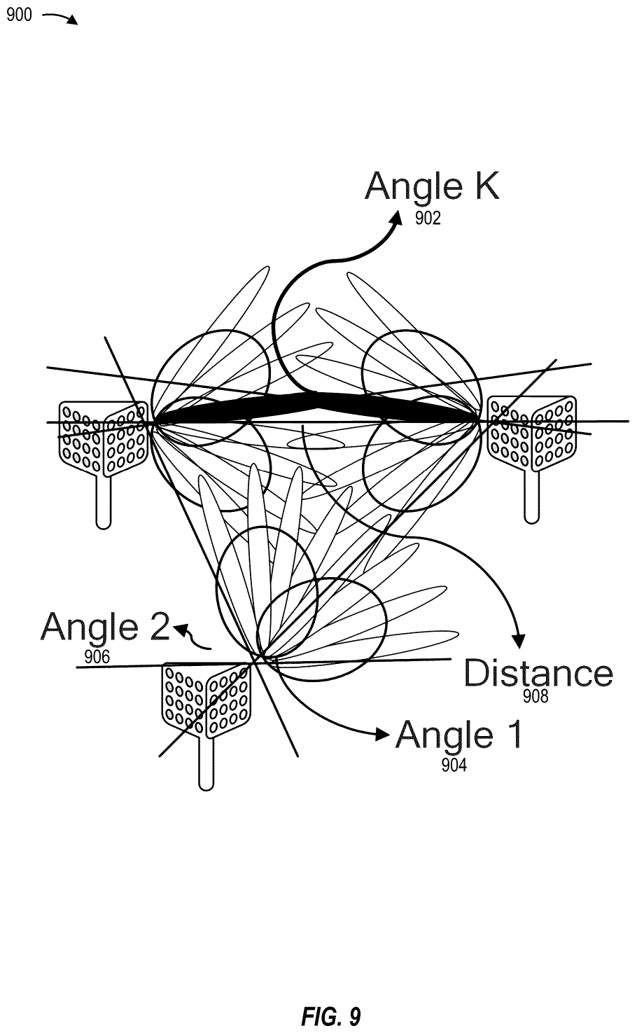

FIG. 9 depicts a diagram 900 illustrating example topological information between network nodes, in accordance with certain aspects of the present disclosure.

As illustrated at 902, for example, topological information may include information regarding Angle K, representing an angle between beams from two cells. As illustrated at 904 and 906, topological information may include information regarding Angle 1/Angle 2, representing angles (e.g., or angle ranges) between cells or angles of beams relative to cells (e.g., measured from the line connecting two cells). As illustrated at 908, topological information may include information regarding a distance (e.g., or distance range) between cells (e.g., inter-cell distance).

In some aspects, inter-node signaling may be advantageous (e.g., or needed) for determining topological information (e.g., complete or pairwise).

In some aspects, the indicated (e.g., pairwise) topological information may contain cell-level information. For example, cell-level topological information may include geographical cell layout information, information regarding how antennas are directed and tilted (e.g., a quantity of cells/gNBs, an inter-cell distance, and/or angles between the cells), and/or information regarding transmit power (e.g., the transmit power (in dB) relative to when training data was collected).

In some aspects, the topological information may contain beam-level information. For example, beam-level topological information may include geographical beam layout information, such as information regarding how beams are numbered, directed, and tilted, beam index or beam group information (e.g., to provide a new mapping compared to when training data was collected), information regarding an angle of the beam(s) relative to cells (e.g., measured from the line connecting two cells), and/or information regarding an angle between beams from two cells. In some aspects, the beam-level information may include information regarding transmit power (e.g., the transmit power (in dB) relative to when training data was collected).

In some aspects, a source node may compute the required information to develop complete layout information. This information may be obtained using various techniques/signaling.

In some aspects, for example, neighboring cells may exchange beam information (e.g., beam index and other information) with a source cell, and the source cell may map the information to an ID. For example, an additional ID, δ^{S}, may be introduced representing the neighbor cell's relationship information with the source cell. This ID may be exchanged using Xn/F1 signaling with neighboring cells.

In some aspects, Operations, Administration and Maintenance (OAM) may provide layout information to the source cell, or may provide an ID to represent topological information and/or a given deployment. The ID may be reused for same/similar topological information/deployment. In some aspects, complete layout information (e.g., or the required information to develop complete layout information) may be obtained based on over-the-top or offline engineering, for example, using crowd sourced data (e.g., data sourced by multiple users/sources).

In some aspects, a UE may be provided with complete layout information and/or associated IDs. For example, a UE may be product with

$${F}_{R} = \{ {F}_{R}^{s} , {F}_{R}^{N 1} , {F}_{R}^{N 2} , … {F}_{R}^{N k} \} ,$$

where

$${F}_{R}^{s} = \{ {A}^{s} , {B}^{s} , {Φ}^{s} , {δ}^{S} \}$$

indicates the resource configuration and associated ID at the serving cell and neighbor cell relationship information of the source, and where

$${F}_{R}^{N M} = \{ {A}^{N M} , {B}^{N M} , {Φ}^{N M} , {δ}^{N M} \}$$

indicates the resource configuration and associated ID at the serving cell and neighbor cell relationship information of the Mth neighboring cell. δ^{S} consolidates a cell's relationship with all (other) neighboring cells using a single ID.

In some aspects, the indicated (e.g., pairwise) topological information may contain cell-level information. For example, cell-level topological information may contain geographical cell layout information, information regarding how antennas are directed and tilted (e.g., distance range(s), angle range(s)), and/or information regarding transmit power (e.g., the transmit power (in dB) relative to when training data was collected).

In some aspects, the topological information may contain beam-level information. For example, beam-level topological information may contain geographical beam layout information, such as information regarding how beams are numbered, directed, and tilted, beam index or beam group information (e.g., to provide a new mapping compared to when training data was collected), information regarding an angle of the beam(s) relative to cells (e.g., measured from the line connecting two cells), and/or information regarding an angle between beams from two cells. In some aspects, the beam-level information may include information regarding transmit power (e.g., the transmit power (in dB) relative to when training data was collected).

In some aspects, a source node may compute the required information to develop pairwise layout information. In some aspects, inter-node signaling may be communicated between neighboring cells to exchange beam information (e.g., beam index with source cell). In some aspects, the signaling may indicate source map pairwise topological information with an identifier (ID) and/or a neighbor cell relationship ID. For example, an additional ID, {δ^{SN1}, . . . , δ^{SNK}, δ^{N1N2}, . . . , δ^{N1Nk}, . . . , . . . }, may be introduced, the ID representing the pairwise neighbor cells relationship information with a source cell.

In some aspects, a cell (e.g., a neighboring cell) may share, with a (e.g., source) cell, its pairwise relationship with other neighboring cells without a new ID. For example, a cell may provide other cell(s) (e.g., source and/or neighboring cells) with F_{R}={A, B, Φ₀, Φ₁, . . . , Φ_{K}}, where Φ₀ is the associated ID representing a local configuration, and where {Φ₁, . . . , Φ_{K}} represents the cell's relationship with its neighboring cells. The source cell may retrieve any other available pairwise information from the neighboring cells. This information (e.g., associated ID(s)) may be exchanged over Xn/F1 signaling with neighboring cells.

As noted above, a UE may be provided with pairwise topological information or associated IDs. For example, UE may be provided with

$${F}_{R} = \{ {F}_{R}^{s} , {F}_{R}^{N 1} , {F}_{R}^{N 2} , … {F}_{R}^{N k} \} ,$$

where

$${F}_{R}^{s} = \{ {A}^{s} , {B}^{s} , {Φ}^{s} , {δ}^{S} \}$$

indicates the resource configuration and associated ID at a serving cell and neighbor cell relationship information of the source, where

$${F}_{R}^{N M} = \{ {A}^{N M} , {B}^{N M} , {Φ}^{N M} , {δ}^{N M} \}$$

indicates the resource configuration and associated ID at the serving cell and neighbor cell relationship information of the Mth neighboring cell, and where, δ^{S}={δ^{SN1}, . . . , δ^{SNK}}, . . . , δ^{NM}={δ^{NMN1}, . . . , δ^{NMNK}}.

In another example, a UE may be provided with

$${F}_{R} = \{ {F}_{R}^{s} , {F}_{R}^{N 1} , {F}_{R}^{N 2} , … {F}_{R}^{N k} \} ,$$

where

$${F}_{R}^{s} = \{ {A}^{s} , {B}^{s} , {Φ}_{0}^{S} , … , {Φ}_{N K}^{S} \}$$

indicates the resource configuration and associated ID at a serving cell and neighbor cell relationship information of the source with its neighbors, and

$${F}_{R}^{N M} = \{ {A}^{N M} , {B}^{N M} , {Φ}_{0}^{N M} , … {Φ}_{N K}^{N M} \}$$

indicates the resource configuration and associated ID at the serving cell and neighbor cell relationship information of the Mth neighboring cell with its neighbors.

Utilization of the techniques disclosed herein may help improve beam prediction. Improved beam prediction may result in improved reliability and performance, which may lead to better quality of service and user experience.

### Example Operations

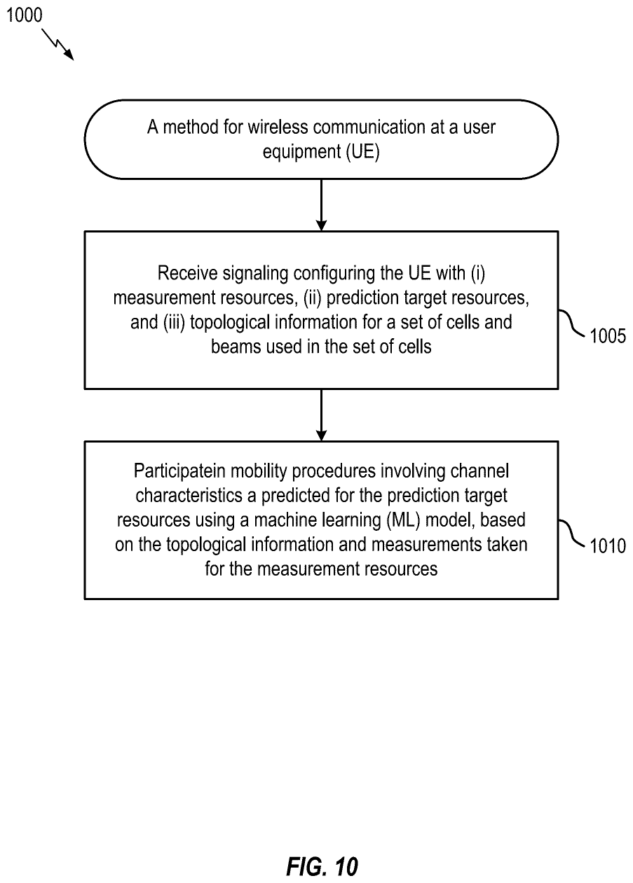

FIG. 10 shows an example of a method 1000 of wireless communication at a user equipment (UE), such as a UE 104 of FIGS. 1 and 3.

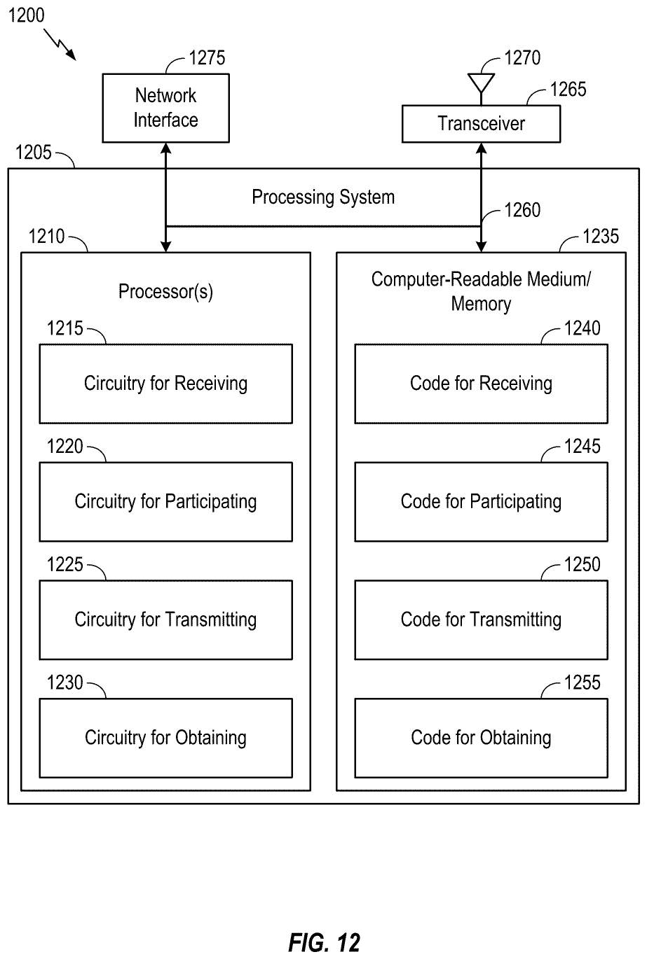

Method 1000 begins at step 1005 with receiving signaling configuring the UE with (i) measurement resources, (ii) prediction target resources, and (iii) topological information for a set of cells and beams used in the set of cells. In some cases, the operations of this step refer to, or may be performed by, circuitry for receiving and/or code for receiving as described with reference to FIG. 12.

Method 1000 then proceeds to step 1010 with participating in mobility procedures involving channel characteristics a predicted for the prediction target resources using a machine learning (ML) model, based on the topological information and measurements taken for the measurement resources. In some cases, the operations of this step refer to, or may be performed by, circuitry for participating and/or code for participating as described with reference to FIG. 12.

In some aspects, the participating comprises transmitting a report based on the predictions.

In some aspects, the predictions relate to at least one of radio link failure (RLF) or handover failure (HOF).

In some aspects, the topological information indicates how beams are deployed in neighboring cells.

In some aspects, the topological information indicates how beams deployed in neighboring cells are correlated via one or more correlation metrics.

In some aspects, the one or more correlation metrics indicate at least one of overlap or a relative tilt between beams in neighboring cells.

In some aspects, the topological information indicates at least one of: how beams are deployed for a region; or relationships between beams of at least first and second cells.

In some aspects, the topological information indicates cell-level information for the region and beam-level information for the region.

In some aspects, the cell-level information comprises at least one of: information regarding geographical cell layout with antenna information; or information regarding transmit power, wherein the information regarding the transmit power comprises an absolute transmit power or a transmit power relative to when training data was collected.

In some aspects, the information regarding geographical cell layout comprises at least one of: a quantity of cells in the region; distance ranges; angle ranges; at least one inter-cell distance between cells; or at least one angle between cells.

In some aspects, the beam-level information comprises at least one of: information regarding how beams are numbered, directed and tilted; beam indices or beam group information; an angle of a beam relative to a line connecting cells; an angle between beams in different cells; or information regarding transmit power.

In some aspects, the topological information is indicated, for a given area, via an associated ID and a parameter that indicates a relationship one or more neighboring cells.

In some aspects, the given area is associated with at least one of: a geographical area, one or more cells, one or more gNBs, or a radio access network (RAN) notification area.

In some aspects, the topological information is indicated, for a given pair of cells, via an associated ID and a parameter that indicates a relationship between the pair of cells.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

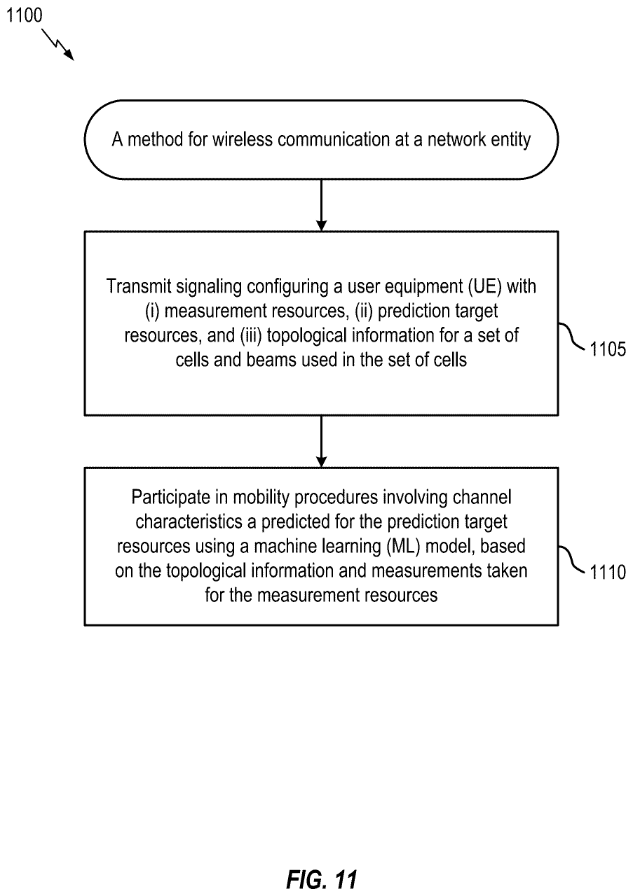

FIG. 11 shows an example of a method 1100 of wireless communication at a network entity, such as a BS 102 of FIGS. 1 and 3, or a disaggregated base station as discussed with respect to FIG. 2.

Method 1100 begins at step 1105 with transmitting signaling configuring a user equipment (UE) with (i) measurement resources, (ii) prediction target resources, and (iii) topological information for a set of cells and beams used in the set of cells. In some cases, the operations of this step refer to, or may be performed by, circuitry for transmitting and/or code for transmitting as described with reference to FIG. 12.

Method 1100 then proceeds to step 1110 with participating in mobility procedures involving channel characteristics a predicted for the prediction target resources using a machine learning (ML) model, based on the topological information and measurements taken for the measurement resources. In some cases, the operations of this step refer to, or may be performed by, circuitry for participating and/or code for participating as described with reference to FIG. 12.

In some aspects, the participating comprises receiving a report based on the predictions.

In some aspects, the predictions relate to at least one of radio link failure (RLF) or handover failure (HOF).

In some aspects, the topological information indicates how beams are deployed in neighboring cells.

In some aspects, the topological information indicates how beams deployed in neighboring cells are correlated via one or more correlation metrics.

In some aspects, the one or more correlation metrics indicate at least one of overlap or a relative tilt between beams in neighboring cells.

In some aspects, the topological information indicates at least one of: how beams are deployed for a region; or relationships between beams of at least first and second cells.

In some aspects, the topological information indicates cell-level information for the region and beam-level information for the region.

In some aspects, the cell-level information comprises at least one of: information regarding geographical cell layout with antenna information; or information regarding transmit power, wherein the information regarding the transmit power comprises an absolute transmit power or a transmit power relative to when training data was collected.

In some aspects, the information regarding geographical cell layout comprises at least one of: a quantity of cells in the region; distance ranges; angle ranges; at least one inter-cell distance between cells; or at least one angle between cells.

In some aspects, the beam-level information comprises at least one of: information regarding how beams are numbered, directed and tilted; beam indices or beam group information; an angle of a beam relative to a line connecting cells; an angle between beams in different cells; or information regarding transmit power.

In some aspects, the topological information is indicated, for a given area, via an associated ID and a parameter that indicates a relationship one or more neighboring cells.

In some aspects, the given area is associated with at least one of: a geographical area, one or more cells, one or more gNBs, or a radio access network (RAN) notification area.

In some aspects, the topological information is indicated, for a given pair of cells, via an associated ID and a parameter that indicates a relationship between the pair of cells.

In some aspects, the method 1100 further includes obtaining topological information associated with the set of cells and beams, wherein the signaling is based on the obtained topological information. In some cases, the operations of this step refer to, or may be performed by, circuitry for obtaining and/or code for obtaining as described with reference to FIG. 12.

In some aspects, the obtained topological information is based on at least one: communication with one or more neighboring cells; Operations, Administration and Maintenance (OAM) signaling; or crowd sourced data.

In one aspect, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative steps are possible consistent with this disclosure.

### Example Communications Device(s)

FIG. 12 depicts aspects of an example communications device 1200. In some aspects, communications device 1200 is a user equipment, such as UE 104 described above with respect to FIGS. 1 and 3. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1265 (e.g., a transmitter and/or a receiver). In some aspects (e.g., when communications device 1200 is a network entity), processing system 1205 may be coupled to a network interface 1275 that is configured to obtain and send signals for the communications device 1200 via communication link(s), such as a backhaul link, midhaul link, and/or fronthaul link as described herein, such as with respect to FIG. 2. The transceiver 1265 is configured to transmit and receive signals for the communications device 1200 via the antenna 1270, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1235 via a bus 1260. In certain aspects, the computer-readable medium/memory 1235 is configured to store instructions (e.g., computer-executable code) that when executed by the one or more processors 1210, cause the one or more processors 1210 to perform the method 1000 described with respect to FIG. 10, or any aspect related to it; and the method 1100 described with respect to FIG. 11, or any aspect related to it. Note that reference to a processor performing a function of communications device 1200 may include one or more processors 1210 performing that function of communications device 1200.

In the depicted example, computer-readable medium/memory 1235 stores code (e.g., executable instructions), such as code for receiving 1240, code for participating 1245, code for transmitting 1250, and code for obtaining 1255. Processing of the code for receiving 1240, code for participating 1245, code for transmitting 1250, and code for obtaining 1255 may cause the communications device 1200 to perform the method 1000 described with respect to FIG. 10, or any aspect related to it; and the method 1100 described with respect to FIG. 11, or any aspect related to it.

The one or more processors 1210 include circuitry configured to implement (e.g., execute) the code stored in the computer-readable medium/memory 1235, including circuitry for receiving 1215, circuitry for participating 1220, circuitry for transmitting 1225, and circuitry for obtaining 1230. Processing with circuitry for receiving 1215, circuitry for participating 1220, circuitry for transmitting 1225, and circuitry for obtaining 1230 may cause the communications device 1200 to perform the method 1000 described with respect to FIG. 10, or any aspect related to it; and the method 1100 described with respect to FIG. 11, or any aspect related to it.

Various components of the communications device 1200 may provide means for performing the method 1000 described with respect to FIG. 10, or any aspect related to it; and the method 1100 described with respect to FIG. 11, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1265 and the antenna 1270 of the communications device 1200 in FIG. 12. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1265 and the antenna 1270 of the communications device 1200 in FIG. 12.

### EXAMPLE CLAUSES

Implementation examples are described in the following numbered clauses:
Clause 1: A method for wireless communication at a user equipment (UE), comprising: receiving signaling configuring the UE with (i) measurement resources, (ii) prediction target resources, and (iii) topological information for a set of cells and beams used in the set of cells; and participating in mobility procedures involving channel characteristics a predicted for the prediction target resources using a machine learning (ML) model, based on the topological information and measurements taken for the measurement resources.
Clause 2: The method of Clause 1, wherein the participating comprises transmitting a report based on the predictions.
Clause 3: The method of any one of Clauses 1-2, wherein the predictions relate to at least one of radio link failure (RLF) or handover failure (HOF).
Clause 4: The method of any one of Clauses 1-3, wherein the topological information indicates how beams are deployed in neighboring cells.
Clause 5: The method of Clause 4, wherein the topological information indicates how beams deployed in neighboring cells are correlated via one or more correlation metrics.
Clause 6: The method of Clause 5, wherein the one or more correlation metrics indicate at least one of overlap or a relative tilt between beams in neighboring cells.
Clause 7: The method of Clause 4, wherein the topological information indicates at least one of: how beams are deployed for a region; or relationships between beams of at least first and second cells.
Clause 8: The method of Clause 7, wherein the topological information indicates cell-level information for the region and beam-level information for the region.
Clause 9: The method of Clause 8, wherein the cell-level information comprises at least one of: information regarding geographical cell layout with antenna information; or information regarding transmit power, wherein the information regarding the transmit power comprises an absolute transmit power or a transmit power relative to when training data was collected.
Clause 10: The method of Clause 9, wherein the information regarding geographical cell layout comprises at least one of: a quantity of cells in the region; distance ranges; angle ranges; at least one inter-cell distance between cells; or at least one angle between cells.
Clause 11: The method of Clause 8, wherein the beam-level information comprises at least one of: information regarding how beams are numbered, directed and tilted; beam indices or beam group information; an angle of a beam relative to a line connecting cells; an angle between beams in different cells; or information regarding transmit power.
Clause 12: The method of Clause 7, wherein the topological information is indicated, for a given area, via an associated ID and a parameter that indicates a relationship one or more neighboring cells.
Clause 13: The method of Clause 12, wherein the given area is associated with at least one of: a geographical area, one or more cells, one or more gNBs, or a radio access network (RAN) notification area.
Clause 14: The method of Clause 7, wherein the topological information is indicated, for a given pair of cells, via an associated ID and a parameter that indicates a relationship between the pair of cells.
Clause 15: A method for wireless communication at a network entity, comprising: transmitting signaling configuring a user equipment (UE) with (i) measurement resources, (ii) prediction target resources, and (iii) topological information for a set of cells and beams used in the set of cells; and participating in mobility procedures involving channel characteristics a predicted for the prediction target resources using a machine learning (ML) model, based on the topological information and measurements taken for the measurement resources.
Clause 16: The method of Clause 15, wherein the participating comprises receiving a report based on the predictions.
Clause 17: The method of any one of Clauses 15-16, wherein the predictions relate to at least one of radio link failure (RLF) or handover failure (HOF).
Clause 18: The method of any one of Clauses 15-17, wherein the topological information indicates how beams are deployed in neighboring cells.
Clause 19: The method of Clause 18, wherein the topological information indicates how beams deployed in neighboring cells are correlated via one or more correlation metrics.
Clause 20: The method of Clause 19, wherein the one or more correlation metrics indicate at least one of overlap or a relative tilt between beams in neighboring cells.
Clause 21: The method of Clause 18, wherein the topological information indicates at least one of: how beams are deployed for a region; or relationships between beams of at least first and second cells.
Clause 22: The method of Clause 21, wherein the topological information indicates cell-level information for the region and beam-level information for the region.
Clause 23: The method of Clause 22, wherein the cell-level information comprises at least one of: information regarding geographical cell layout with antenna information; or information regarding transmit power, wherein the information regarding the transmit power comprises an absolute transmit power or a transmit power relative to when training data was collected.
Clause 24: The method of Clause 23, wherein the information regarding geographical cell layout comprises at least one of: a quantity of cells in the region; distance ranges; angle ranges; at least one inter-cell distance between cells; or at least one angle between cells.
Clause 25: The method of Clause 22, wherein the beam-level information comprises at least one of: information regarding how beams are numbered, directed and tilted; beam indices or beam group information; an angle of a beam relative to a line connecting cells; an angle between beams in different cells; or information regarding transmit power.
Clause 26: The method of Clause 21, wherein the topological information is indicated, for a given area, via an associated ID and a parameter that indicates a relationship one or more neighboring cells.
Clause 27: The method of Clause 26, wherein the given area is associated with at least one of: a geographical area, one or more cells, one or more gNBs, or a radio access network (RAN) notification area.
Clause 28: The method of Clause 21, wherein the topological information is indicated, for a given pair of cells, via an associated ID and a parameter that indicates a relationship between the pair of cells.
Clause 29: The method of any one of Clauses 15-28, further comprising: obtaining topological information associated with the set of cells and beams, wherein the signaling is based on the obtained topological information.
Clause 30: The method of Clause 29, wherein the obtained topological information is based on at least one: communication with one or more neighboring cells; Operations, Administration and Maintenance (OAM) signaling; or crowd sourced data.
Clause 31: An apparatus, comprising: at least one memory comprising executable instructions; and at least one processor configured to execute the executable instructions and cause the apparatus to perform a method in accordance with any combination of Clauses 1-30.
Clause 32: An apparatus, comprising means for performing a method in accordance with any combination of Clauses 1-30.
Clause 33: A non-transitory computer-readable medium comprising executable instructions that, when executed by at least one processor of an apparatus, cause the apparatus to perform a method in accordance with any combination of Clauses 1-30.
Clause 34: A computer program product embodied on a computer-readable storage medium comprising code for performing a method in accordance with any combination of Clauses 1-30.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for participating, means for transmitting, and means for obtaining may comprise one or more processors, such as one or more of the processors described above with reference to FIG. 12.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive signaling configuring the UE with (i) measurement resources, (ii) prediction target resources, and (iii) topological information for a set of cells and beams used in the set of cells; and
participate in mobility procedures involving channel characteristics a predicted for the prediction target resources using a machine learning (ML) model, based on the topological information and measurements taken for the measurement resources.

2. The apparatus of claim 1, wherein the participating comprises transmitting a report based on the predictions.

3. The apparatus of claim 1, wherein the predictions relate to at least one of radio link failure (RLF) or handover failure (HOF).

4. The apparatus of claim 1, wherein the topological information indicates how beams are deployed in neighboring cells.

5. The apparatus of claim 4, wherein the topological information indicates how beams deployed in neighboring cells are correlated via one or more correlation metrics.

6. The apparatus of claim 5, wherein the one or more correlation metrics indicate at least one of overlap or a relative tilt between beams in neighboring cells.

7. The apparatus of claim 4, wherein the topological information indicates at least one of: how beams are deployed for a region; or relationships between beams of at least first and second cells.

8. The apparatus of claim 7, wherein the topological information indicates cell-level information for the region and beam-level information for the region.

9. The apparatus of claim 8, wherein the cell-level information comprises at least one of: information regarding geographical cell layout with antenna information; or information regarding transmit power for the region, wherein the information regarding the transmit power comprises an absolute transmit power or a transmit power relative to when training data was collected.

10. The apparatus of claim 9, wherein the information regarding geographical cell layout comprises at least one of: a quantity of cells in the region; distance ranges; angle ranges; at least one inter-cell distance between cells; or at least one angle between cells.

11. The apparatus of claim 8, wherein the beam-level information comprises at least one of: information regarding how beams are numbered, directed and tilted; beam indices or beam group information; an angle of a beam relative to a line connecting cells; an angle between beams in different cells; or information regarding transmit power for the region.

12. The apparatus of claim 7, wherein the topological information is indicated, for a given area, via an associated ID and a parameter that indicates a relationship one or more neighboring cells.

13. The apparatus of claim 12, wherein the given area is associated with at least one of: a geographical area, one or more cells, one or more gNBs, or a radio access network (RAN) notification area.

14. The apparatus of claim 7, wherein the topological information is indicated, for a given pair of cells, via an associated ID and a parameter that indicates a relationship between the pair of cells.

15. An apparatus for wireless communication, comprising:
at least one memory comprising computer-executable instructions; and
one or more processors configured to execute the computer-executable instructions and cause the apparatus to:
transmit signaling configuring a user equipment (UE) with (i) measurement resources, (ii) prediction target resources, and (iii) topological information for a set of cells and beams used in the set of cells; and
participate in mobility procedures involving channel characteristics a predicted for the prediction target resources using a machine learning (ML) model, based on the topological information and measurements taken for the measurement resources.

16. The apparatus of claim 15, wherein the participating comprises receiving a report based on the predictions.

17. The apparatus of claim 15, wherein the predictions relate to at least one of radio link failure (RLF) or handover failure (HOF).

18. The apparatus of claim 15, wherein the topological information indicates how beams are deployed in neighboring cells.

19. The apparatus of claim 18, wherein the topological information indicates how beams deployed in neighboring cells are correlated via one or more correlation metrics.

20. The apparatus of claim 19, wherein the one or more correlation metrics indicate at least one of overlap or a relative tilt between beams in neighboring cells.

21. The apparatus of claim 18, wherein the topological information indicates at least one of: how beams are deployed for a region; or relationships between beams of at least first and second cells.

22. The apparatus of claim 21, wherein the topological information indicates cell-level information for the region and beam-level information for the region.

23. The apparatus of claim 22, wherein the cell-level information comprises at least one of: information regarding geographical cell layout with antenna information; or information regarding transmit power for the region, wherein the information regarding the transmit power comprises an absolute transmit power or a transmit power relative to when training data was collected.

24. The apparatus of claim 23, wherein the information regarding geographical cell layout comprises at least one of: a quantity of cells in the region; distance ranges; angle ranges; at least one inter-cell distance between cells; or at least one angle between cells.

25. The apparatus of claim 22, wherein the beam-level information comprises at least one of: information regarding how beams are numbered, directed and tilted; beam indices or beam group information; an angle of a beam relative to a line connecting cells; an angle between beams in different cells; or information regarding transmit power for the region.

26. The apparatus of claim 21, wherein the topological information is indicated, for a given area, via an associated ID and a parameter that indicates a relationship one or more neighboring cells.

27. The apparatus of claim 26, wherein the given area is associated with at least one of: a geographical area, one or more cells, one or more gNBs, or a radio access network (RAN) notification area.

28. The apparatus of claim 21, wherein the topological information is indicated, for a given pair of cells, via an associated ID and a parameter that indicates a relationship between the pair of cells.

29. A method for wireless communication at a user equipment (UE), comprising:
receiving signaling configuring the UE with (i) measurement resources, (ii) prediction target resources, and (iii) topological information for a set of cells and beams; and
participating in mobility procedures involving a machine learning (ML) model and predictions for the prediction target resources, based on the topological information and measurements taken for the measurement resources.

30. A method for wireless communication at a network entity, comprising:
transmitting signaling configuring a user equipment (UE) with (i) measurement resources, (ii) prediction target resources, and (iii) topological information for a set of cells and beams; and
participating in mobility procedures involving a machine learning (ML) model and predictions for the prediction target resources, based on the topological information and measurements taken for the measurement resources.
